(19) United States
(12) Patent Application Publication
(10) Pub. No.: US 2014/0061292 A1
(43) Pub. Date: Mar. 6, 2014

(54) Intelligent Marketing Hardware and Software, Methods and Uses Thereof

(71) Applicants: Paul A. Meyers, Los Angeles, CA (US); Matthew G. Rosenzweig, Studio City, CA (US)

(72) Inventors: Paul A. Meyers, Los Angeles, CA (US); Matthew G. Rosenzweig, Studio City, CA (US)

(21) Appl. No.: 13/599,545

(22) Filed: Aug. 30, 2012

(51) Int. Cl. G06Q 30/02

(52) U.S. Cl. 235/375

(57) ABSTRACT

Contemplated systems comprise: a) an information repository that comprises a display device, a unique code generator, a portable device communication system, an information transfer system and an information storage system; b) a handheld device, portable device or combination thereof, and c) at least one piece of information. Methods of utilizing contemplated systems comprise: a) providing an information repository that comprises a display device, a unique code generator, a portable device communication system, an information transfer system and an information storage system; b) providing a handheld device, portable device or combination thereof, c) providing at least one piece of information on the information repository, d) generating a unique QR code or unique scannable or readable code with the unique code generator, and e) accessing the at least one piece of information stored on the information repository by utilizing the handheld device, portable device or combination thereof to scan the unique QR code.

### FIELD OF THE SUBJECT MATTER

The field of the subject matter is intelligent marketing hardware and software, related methods, and their use by consumers and potential consumers.

### BACKGROUND

Companies and marketing agencies are always innovating ways to connect with customers and potential consumers, as well as tracking the interactions, connections and sales. This information is critical to the company with respect to product development and customer service. These companies want to market test products and services, track sales and interest, along with collecting consumer and potential consumer information for follow up later.

Right now, there are several methods being used by companies to gather and utilize this information. First, companies utilize surveys and internet or local computer interface screens to actively request information from a consumer or potential consumer. This system however, requires the customer or potential customer stop what he or she is looking at or for on the internet, and then take the time to provide information. In reality, whether that interface takes someone 5 minutes or 10 minutes to fill out, that person is likely to navigate away from that page without taking the time. Another system collects the individual's computer information, such as the IP address of the user, and “follows” that user around while he or she surfs the internet and provides ad content specifically targeted to that user. Both of these systems fail, however, because they don't collect some pieces of information that would help the company develop new products and services or develop marketing campaigns for current products and services.

A new method that is being utilized is the QR code, which is a square bar-code-type of display that can be scanned and “decoded” by a smart phone application or hand held device application. These QR codes contain information or direct the devices to links where the user can get more information about the item that the QR code is associated with. So, a user can walk up to a movie poster, scan a QR code that is in the corner of the poster and get information about the movie, the stars, the critics reviews and other things that the movie promoters want to push out to the public. This process, however, isn't a two-way marketing process, because it doesn't allow the movie promoter to collect information about the consumer or potential consumer.

To this end, it would be desirable to develop, produce and utilize a two-way marketing and information tool that: a) is both hardware and software based, b) is stored on at least one computer readable storage medium, c) securely collects and stores information about the consumer or potential consumer, d) provides a rewards system or an incentive to the consumer or potential consumer, and e) does not require any time commitment by the consumer or potential consumer to provide information or review information from the company or marketing team.

### SUMMARY OF THE SUBJECT MATTER

Contemplated systems comprise: a) an information repository that comprises a display device, a unique code generator, a portable device communication system, an information transfer system and an information storage system; b) a handheld device, portable device or combination thereof, and c) at least one piece of information. In some embodiments, a contemplated handheld device, portable device or combination thereof may comprise a software “app” that is designed to track interactions with contemplated systems, catalog that information, present it to the user when demanded, or a combination thereof.

Methods of utilizing contemplated systems comprise: a) providing an information repository that comprises a display device, a unique code generator, a portable device communication system, an information transfer system and an information storage system; b) providing a handheld device, portable device or combination thereof, c) providing at least one piece of information on the information repository, d) generating a unique QR code or unique scannable or readable code with the unique code generator, and e) accessing the at least one piece of information stored on the information repository by utilizing the handheld device, portable device or combination thereof to scan the unique QR code or unique scannable or readable code.

### BRIEF DESCRIPTION OF THE FIGURES

FIG. 1 shows a flowchart schematic of a contemplated system.

FIG. 2 shows a flowchart schematic of a contemplated system.

### DETAILED DESCRIPTION

A two-way marketing and information tool has, in fact, been developed that: a) is both hardware and software based, b) is stored on at least one computer readable storage medium, c) securely collects and stores information about the consumer or potential consumer, d) provides a rewards system or an incentive to the consumer or potential consumer, and e) does not require any time commitment by the consumer or potential consumer to provide information or review information from the company or marketing team.

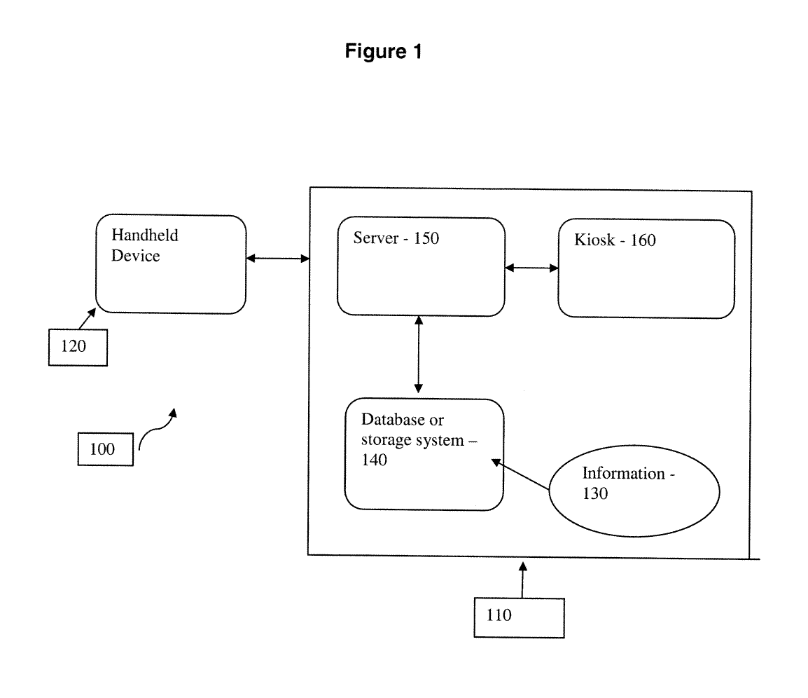

Contemplated systems 100, as shown in FIG. 1, comprise: a) an information repository 110 that comprises a display device, a unique code generator, a portable device communication system, an information transfer system and an information storage system; b) a handheld device, portable device or combination thereof 120, and c) at least one piece of information 130. In this embodiment, the information repository comprises a server 150 (a unique code generator, a portable device communication system, an information transfer system), a kiosk 160 (a display device) and a database or information storage system 140.

In some embodiments, a contemplated handheld device, portable device or combination thereof may comprise a software “app” that is designed to track interactions with contemplated systems, catalog that information, present it to the user when demanded, or a combination thereof. In contemplated embodiments and as will be described herein, a unique code generator is designed to randomly generate a unique code that can be associated with one potential consumer. In some embodiments, a contemplated unique code will be a QR code.

Methods of utilizing contemplated systems 200 comprise: a) providing 210 an information repository that comprises a display device, a unique code generator, a portable device communication system, an information transfer system and an information storage system; b) providing 220 a handheld device, portable device or combination thereof, c) providing 230 at least one piece of information on the information repository, d) generating 240 a unique QR code or unique scannable or readable code with the unique code generator, and e) accessing 250 the at least one piece of information stored on the information repository by utilizing the handheld device, portable device or combination thereof to scan the unique QR code.

One of the keys of contemplated systems is the ability of the information repository to generate a unique QR code or unique scannable or readable code for each consumer using the unique code generator that randomly generates a unique code, such as an individual QR code. It should be noted that all QR codes are unique to a user. In many other conventional instances, one QR code is used to provide a link from the user to an advertisement or information related to a product or service. In contemplated embodiments, unique QR codes or other unique codes are generated for each potential or actual consumer who actively participates in and/or utilizes the system and methods.

Contemplated unique scannable or readable codes are designed to be scanned or “read” by a portable device, handheld device or combination thereof. A QR code is a subset of the unique scannable or readable codes. As used here, a QR code—abbreviated from Quick Response Code—is a type of matrix barcode (or two-dimensional code) first designed for the automotive industry. More recently, the system has become popular outside of the industry due to its fast readability and large storage capacity compared to standard UPC barcodes. The code consists of black modules arranged in a square pattern on a white background. The information encoded can be made up of four standardized kinds (“modes”) of data (numeric, alphanumeric, byte/binary, Kanji), or by supported extensions virtually any kind of data. (www.wikipedia.org)

Contemplated systems, as disclosed, comprise an information repository that comprises a display device, a QR code or unique code generator, a portable device communication system, an information transfer system and an information storage system. In some embodiments, a contemplated information repository is a kiosk, a digital display or a combination thereof.

As part of these systems, a display device is included that comprises a digital display, an interactive display with keyboard (actual, digital or voice recognition-enabled), a combination digital and paper artwork display or a combination thereof. A unique code generator is also included in contemplated information repositories that are programmed to generate a unique code for each consumer who approaches and interacts with the system. Contemplated portable device communications systems are designed to communicate with the handheld device, portable device or combination thereof. Contemplated information transfer systems collect the information from the device communication system, transmit it to the information storage system and then transmit additional information back to the device communication system.

Contemplated systems also comprise a consumer or potential-consumer utilized handheld device, portable device or combination thereof. Contemplated devices may include a smart phone, hand held device, laptop computer or another suitable device with a network connection, data transfer connection, network data connection, cellular data network and/or connection, Wi-Fi connection, or another suitable device/link combination or connection that allows the user to communicate with the information repository, and specifically the device communications system.

Contemplated systems embodiments and related applications or apps are saved on, executed on, stored on or located on a portable media storage device, a hand held device, a tablet computer, a laptop computer, a desk top computer, a network server, an internet server, the cloud or a combination thereof.

### EXAMPLES

### Example 1

### Movie Opening

Contemplated systems, in some embodiments, connect a user's smartphone to a specific kiosk easily and securely via a dynamically generated unique QR code, allowing smartphone/kiosk connected experiences. This technology also enables kiosk users to authenticate themselves, essentially allowing them to log in to the kiosk without exposing their credentials.

Kiosk users are wary of entering their credentials or information (for example, username and password, name, address, cell phone number) on a public screen because of privacy concerns. A user authenticating on a private screen, such as his or her smartphone, will alleviate his or her concerns. As mentioned, with secure credentials, a kiosk application can be much more targeted and personalized. The kiosk application can access and update the user's accounts in other systems, such as reward points, and social media sites, such as Facebook, Twitter, and others.

Promoters for the movie “Inception” set up kiosks in various locations, including malls, sporting events, concerts and other movie theaters. A person approaches the kiosk and is interested in the movie. There is a “More Information” button on the kiosk screen and the person touches the screen to activate the system. The user is presented with a trailer for the movie, an interview with Leonardo DiCaprio or a combination thereof. When the video has ended, the user is presented with a dynamically generated QR code that is unique to that kiosk. The user is asked to scan the QR code with her smartphone, which she does. The user is then asked to authenticate the interactive communication on her smart phone by logging in with her username and password to a secure site, which she does. The kiosk instantly authenticates the user and presents her with information tailored or personalized to her, including reward points, a coupon, additional content or a combination thereof. The information is then sent to the smart phone, and if the user has an appropriate application, the information is catalogued and saved for later use or review by the user.

### Example 2

### Game Launch

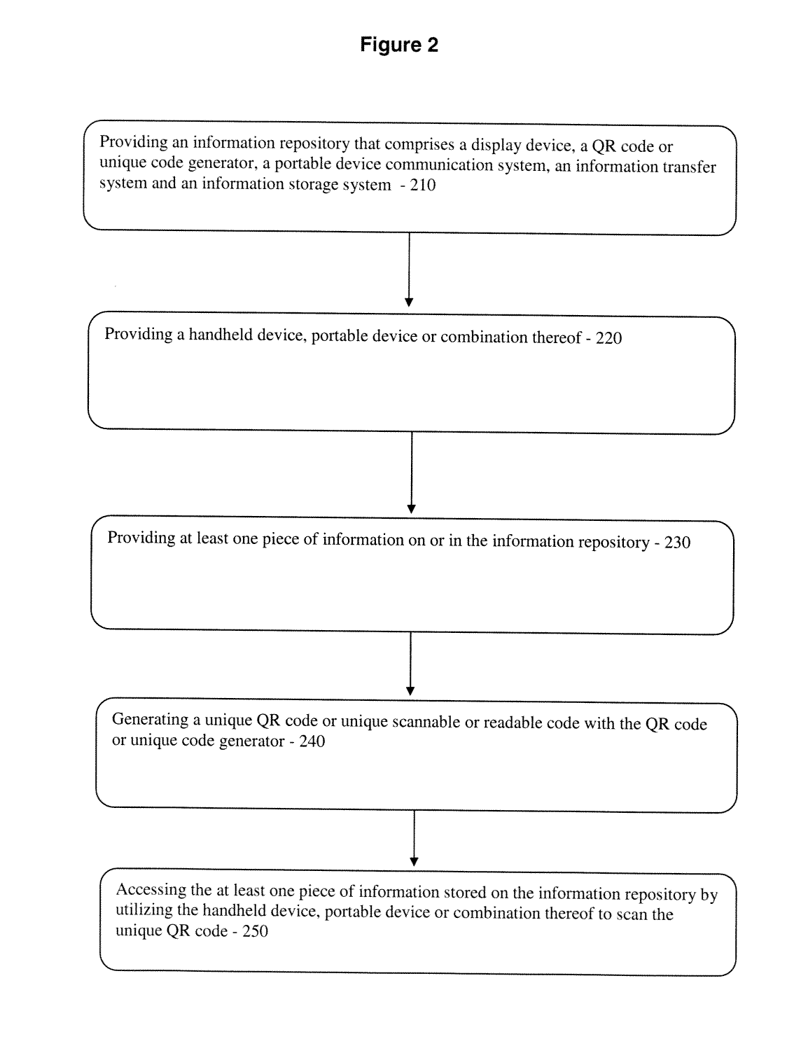

Kiosk users can use their smartphones to control or enhance the kiosk experience, such as using their phone as a controller for a kiosk video game. FIG. 2 shows a flowchart for a contemplated embodiment 200 with a game promotion.

Kiosks 210 in various locations, including malls, sporting events, concerts and other movie theaters (not shown) are set up to promote the new game release “Call of Duty”. These kiosks comprise a digital video display 215. A person (not shown) approaches the kiosk 210 and is interested in the game (not shown). There is a “GET STARTED” button 220 on the kiosk screen 215 and the person touches the screen to activate the system 200. The user is presented with a trailer for the game, an interview with the game designers or a combination thereof 230. When the video has ended, the user is presented with a dynamically generated QR code 240 that is unique to that kiosk 210. The user is asked to scan the QR code 240 with her smartphone (not shown), which she does. The user is then asked to authenticate the interactive communication 250 on her smart phone by logging in with her username and password to a secure site, which she does. The kiosk instantly authenticates 260 the user and presents her with information tailored or personalized to her, including reward points, a coupon, additional game plugins or modules or a combination thereof. The information is then sent to the smart phone 270, and if the user has an appropriate application, the information is catalogued and saved for later use or review by the user 280.

### Example 3

### Sports Event

Kiosks and display devices are set up in various locations around a stadium or sports arena to promote the team and their partners by giving away logo items, gift certificates, free drinks or food and trips. These kiosks comprise a digital video display. A person who enters the stadium or arena to see the game approaches the kiosk and is interested in the giveaway. There is a “GET STARTED” button on the kiosk screen and the person touches the screen to activate the system. The user is presented with a digital wheel to spin, a digital game board or a combination thereof. When the digital wheel or game board is displayed, the user is presented with a dynamically generated QR code that is unique to that kiosk at that location in a particular arena and in a particular area of the arena, such as field level, club level, luxury boxes, view level, etc. The user is asked to scan the QR code with her smartphone (not shown), which she does. The user is then asked to authenticate the interactive communication on her smart phone by logging in with her username and password to a secure site, which she does. The kiosk instantly authenticates the user and presents her with a reward. The information is then sent to the smart phone, and if the user has an appropriate application, the information is catalogued and saved for later use or review by the user. If the reward is a coupon for something at the arena or stadium, the user can use her smartphone to scan the coupon in when she purchases the drink, food item or logo item.

### Example 4

### Bruce Springsteen Concert

Kiosks and display devices are set up in various locations around a concert venue where users are teased to interact with the kiosk by a promise of something “Bruce Springsteen related”. These kiosks comprise a digital video display. A person who enters the stadium or arena to see the game approaches the kiosk and is interested in the giveaway. There is a “GET STARTED” button on the kiosk screen and the person touches the screen to activate the system. The user is presented with a digital wheel to spin, a digital game board or a combination thereof. When the digital wheel or game board is displayed, the user is presented with a dynamically generated QR code that is unique to that kiosk at that location in a particular arena and in a particular area of the arena, such as general admission/floor, luxury boxes, view level, etc. The user is asked to scan the QR code with her smartphone (not shown), which she does. The user is then asked to authenticate the interactive communication on her smart phone by logging in with her username and password to a secure site, which she does. The kiosk instantly authenticates the user and presents her with a reward—whether it is a new song not on the current album, an extended play album or full album or new tour information. The information is then sent to the smart phone, and if the user has an appropriate application, the information is catalogued and saved for later use or review by the user. If the reward is a coupon for something at the arena or stadium, the user can use her smartphone to scan the coupon in when she purchases album, song or band “swag”.

Thus, specific embodiments and methods of is intelligent marketing hardware and software, methods and uses thereof have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An intelligent marketing system, comprising:
an information repository that comprises a display device, a unique code generator, a portable device communication system, an information transfer system and an information storage system;
a handheld device, portable device or combination thereof, and
at least one piece of information, wherein a randomly-generated unique code is associated with the at least one piece of information and not associated with a user or with user information.

2. The intelligent marketing system of claim 1, wherein the information repository is housed in a kiosk, digital display device or a combination thereof.

3. The intelligent marketing system of claim 1, wherein the handheld device, portable device or combination thereof comprises a smart phone, a laptop computer or a tablet computer.

4. The intelligent marketing system of claim 1, wherein the information storage system comprises a database.

5. The intelligent marketing system of claim 1, further comprising a software application stored on the handheld device, portable device or combination thereof.

6. The intelligent marketing system of claim 5, wherein the software application is designed to track interactions with contemplated systems, catalog that information, present it to a user when demanded or requested, or a combination thereof.

7. (canceled)

8. The intelligent marketing system of claim 1, wherein the unique code comprises a QR code.

9. The intelligent marketing system of claim 1, wherein the system is stored on a portable media storage device, a hand held device, a tablet computer, a laptop computer, a desk top computer, a network server, an internet server, the cloud or a combination thereof.

10. A method of utilizing an intelligent marketing system, comprising:
providing an information repository that comprises a display device, a unique code generator, a portable device communication system, an information transfer system and an information storage system;
providing a handheld device, portable device or combination thereof,
providing at least one piece of information on the information repository,
randomly generating a unique QR code or unique scannable or readable code with the QR code or unique code generator, wherein the unique code is associated with the at least one piece of information and not associated with a user or with user information; and
accessing the at least one piece of information stored on the information repository by utilizing the handheld device, portable device or combination thereof to scan the unique QR code or unique scannable or readable code.

11. The method of claim 10, wherein the information repository is housed in a kiosk, digital display device or a combination thereof.

12. The method of claim 10, wherein the handheld device, portable device or combination thereof comprises a smart phone, a laptop computer or a tablet computer.

13. The method of claim 10, wherein the information storage system comprises a database.

14. The method of claim 10, further comprising a software application stored on the handheld device, portable device or combination thereof.

15. The method of claim 14, wherein the software application is designed to track interactions with contemplated systems, catalog that information, present it to a user when demanded or requested, or a combination thereof.

16. (canceled)

17. The method of claim 10, wherein the unique code comprises a QR code.

18. The method of claim 10, wherein the system is stored on a portable media storage device, a hand held device, a tablet computer, a laptop computer, a desk top computer, a network server, an internet server, the cloud or a combination thereof.
